(19) United States
(12) Patent Application Publication
(10) Pub. No.: US 2013/0232304 A1
(43) Pub. Date: Sep. 5, 2013

(54) ACCELERATED INTERLEAVED MEMORY DATA TRANSFERS IN MICROPROCESSOR-BASED SYSTEMS, AND RELATED DEVICES, METHODS, AND COMPUTER-READABLE MEDIA

(71) Applicant: QUALCOMM INCORPORATED, San Diego, CA (US)

(72) Inventors: Terence J. Lohman, Raleigh, NC (US); Brent L. DeGraaf, Raleigh, NC (US); Gregory Allan Reid, Durham, NC (US)

(73) Assignee: QUALCOMM INCORPORATED, San Diego, CA (US)

(21) Appl. No.: 13/784,088

(22) Filed: Mar. 4, 2013

Related U.S. Application Data
(60) Provisional application No. 61/606,757, filed on Mar. 5, 2012.

(51) Int. Cl. G06F 12/08

(52) U.S. Cl. CPC G06F 12/0851
USPC 711/127

(57) ABSTRACT

Accelerated interleaved memory data transfers in microprocessor-based systems and related devices, methods, and computer-readable media are disclosed. Embodiments disclosed in the detailed description include accelerated interleaved memory data transfers in processor-based systems. Related devices, methods, and computer-readable media are also disclosed. Embodiments disclosed include accelerated large and small memory data transfers. As a non-limiting example, a large data transfer is a data transfer size greater than the interleaved address block size provided in the interleaved memory. As another non-limiting example, a small data transfer is a data transfer size less than the interleaved address block size provided in the interleaved memory.

### CLAIM OF PRIORITY UNDER 35 U.S.C. §119

The present application for patent claims priority to Provisional Application No. 61/606,757 entitled ACCELERATED INTERLEAVED MEMORY DATA TRANSFERS IN MICROPROCESSOR-BASED SYSTEMS, AND RELATED DEVICES, METHODS, AND COMPUTER-READABLE MEDIA filed Mar. 5, 2012, and assigned to the assignee hereof and hereby expressly incorporated by reference herein.

### RELATED APPLICATION

The present application is related to U.S. patent application Ser. No. 13/369,548 Docket Number 111094 filed on Feb. 9, 2012 and entitled “DETERMINING OPTIMAL PRELOAD DISTANCE AT RUNTIME,” which is incorporated herein by reference in its entirety.

### BACKGROUND

I. Field of the Disclosure

The technology of the disclosure relates generally to efficient memory data transfers, particularly memory copies, in microprocessor-based systems.

II. Background

Microprocessors perform computational tasks in a wide variety of applications. A typical microprocessor application includes one or more central processing units (CPUs) that execute software instructions. The software instructions instruct a CPU to fetch data from a location in memory, perform one or more CPU operations using the fetched data, and store or accumulate the result. The memory from which the data is fetched can be local to the CPU, within a memory “fabric,” and/or within a distributed resource to which the CPU is coupled. CPU performance is the processing rate, which is measured as the number of operations that can be performed per unit of time (a typical rating is based on one second). The speed of the CPU can be increased by increasing the CPU clock rate. Since many CPU applications require fetching data from the memory fabric, increases in CPU clock speed without like kind decreases in memory fabric fetch times will only increase the amount of wait time in the CPU for the arrival of fetched data.

Memory fetch times have been decreased by employing interleaved memory systems. Interleaved memory systems can also be employed for local memory systems to a CPU. In an interleaved memory system, multiple memory controllers are provided that support interleaving the contiguous address lines between different memory banks in the memory. In this manner, contiguous address lines stored in different memory banks can be simultaneously accessed to increase memory access bandwidth. In a non-interleaved memory system, contiguous lines stored in a memory bank could only be accessed serially. FIG. 1 illustrates an example of an interleaved memory system 10. The memory 12 contains a plurality of memory banks 14(0)-14(2^{K}−1), where ‘k’ is equal to the number of least significant bits (LSBs) in the memory address 16 used to select a particular memory bank 14(0)-14(2^{K}−1) for a memory access. The most significant bits (MSBs) of ‘m’ bits are used to address a line in the selected memory bank 14(0)-14(2^{K}−1). Peak transfer rates (i.e., bandwidth) can be increased by the number of memory banks ‘k’ in the interleaved memory system 10. The data stored at the line address of the selected memory bank 14(0)-14(2^{K}−1) is placed on the data bus 18.

To further illustrate addresses interleaved among different memory banks, FIG. 2 is provided. FIG. 2 illustrates memory interleaving between only two memory banks B₀ and B₁. As shown in FIG. 2, ‘2N’ contiguous address lines of a given line size (also known as the “stride”) are alternatively stored between the two memory banks B₀ and B₁, wherein N is a positive whole number. In this example, two memory controllers would be provided and configured to support interleaving of the ‘2N’ address lines between the two memory banks B₀ and B₁. The first memory controller would be configured to access address lines in the first memory bank B₀. The second memory controller would be configured to access alternating address lines in the second memory bank B₁. Thus, when data is accessed over multiple address lines, the two memory controllers could access memory banks B₀ and B₁ simultaneously to access contiguous memory lines stored in the memory banks B₀ and B₁.

Even though interleaved memory systems provide a theoretical increase in bulk transfer bandwidth, it is difficult for a CPU to use all this bandwidth. The address alignments used by the CPU may not often align with optimal interleaving boundaries in the interleaved memory system. This is because the address alignments used by the CPU are typically created based on the alignments of the memory buffers engaged by the CPU, and not the architecture of the interleaved memory systems. Further, data transfer sizes that are less than the stride of an interleaved memory system may not benefit from the interleaved memory system.

### SUMMARY

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

Aspects of the invention may be characterized as a method for transferring data on a computing device that includes interleaved memory constructs and is capable of issuing an asynchronous load of data to a cache memory in advance of the data being used by a processor. The method may include receiving a first read address associated with a read data stream and receiving a second address that is associated with a second data stream, the second data stream is one of a read or write data stream. In addition, a minimum preload offset is obtained that is based, at least in part, upon the speed of the memory constructs. A next available interleaved memory address is calculated which is in a next adjacent interleave to the second address by adding the obtained interleave size to the second address, and a minimum preload address is calculated by adding the obtained minimum preload offset to the first address. In addition, a raw address distance is calculated by subtracting the minimum preload address from the next available interleaved address, and an interleave size mask is also calculated based upon an interleave stride and an interleave count to strip the higher-order bits from the raw address distance to produce a raw offset from the minimum preload address to a preferred memory preload address. A final preload offset is then calculated from the first read address by adding the minimum preload distance to the calculated raw offset and the final preload offset is used to address-align memory addresses to prevent the read data stream and the second data stream from simultaneously utilizing the memory constructs thereby accelerating the transfer of the data.

Other aspects may be characterized as a computing device that includes at least two memory constructs, a cache memory coupled to store data from the memory constructs, and a processor coupled to the cache memory. The processor may include registers to store a first read address associated with a read data stream and a second address that is associated with a second data stream. The processor may also include system registers including a minimum preload offset, an interleave stride, and an interleave count. In addition, the processor may include raw offset logic to determine a raw offset utilizing the first read address, the second address, the interleave stride, the interleave count, and the minimum preload offset and logic to add the raw offset to the minimum preload offset to obtain a final preload offset. A data prefetch generation component may be included in the processor that uses the final preload offset to prefetch data that is one interleave away from data being accessed at the second address to prevent the read data stream and the second data stream from simultaneously utilizing the memory constructs.

### BRIEF DESCRIPTION OF THE FIGURES

FIG. 1 illustrates an exemplary interleaved memory system;

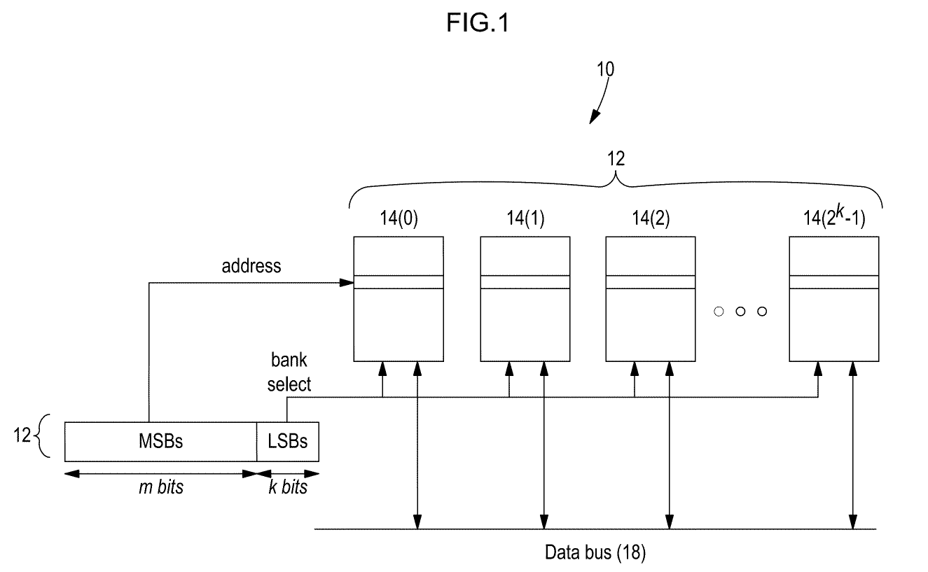

FIG. 2 illustrates two interleaved memory banks;

FIG. 3 is a block diagram of an exemplary processor-based system employing accelerated interleaved memory data transfers;

FIG. 4 is a flow chart depicting a method for determining memory address alignment for accelerated data transfers involving interleaved memory;

FIG. 5 is a block diagram of an example of determining memory address alignment for accelerated data transfers involving interleaved memory;

FIG. 6 is a flow chart depicting another method for determining memory address alignment for accelerated data transfers involving interleaved memory;

FIG. 7A is a block diagram of another example of determining memory address alignment for accelerated data transfers involving interleaved memory;

FIG. 7B is a block diagram of yet another example of determining memory address alignment for accelerated data transfers involving interleaved memory;

FIG. 8 is a graphical representation of a data transfer process;

FIG. 9 is a graphical representation of another data transfer process;

FIG. 10 is a block diagram of an exemplary processor-based system that can include the accelerated data transfers utilizing concurrent address streams to access interleaved memory; and

FIG. 11 is a block diagram depicting an exemplary embodiment of the processor described with reference to FIG. 10.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed herein include accelerated interleaved memory data transfers in processor-based devices and systems. Related devices, methods, and computer-readable media are also disclosed. Embodiments disclosed include accelerated large and small memory data transfers. As a non-limiting example, a large data transfer is a data transfer size greater than the interleaved address block size provided in the interleaved memory. As another non-limiting example, a small data transfer is a data transfer size less than the interleaved address block size provided in the interleaved memory.

To efficiently utilize interleaved memory systems for accelerated data transfers, in certain disclosed embodiments, data streams are address aligned to not access the same memory bank in interleaved memory at the same time during the data transfer. For example, a read data stream involved in a memory data transfer is address aligned so that the read data stream and a write data stream do not access the same memory bank in interleaved memory at the same time during the data transfer. Address alignment provides increased data transfer efficiency for large data transfers where the size of the data transfer is greater than the interleaved address block size. To provide further increases in data transfer efficiency, the memory data to be transferred may also be prefetched or preloaded into faster memory (e.g., faster cache memory) before the transfer operation is executed. In this manner, a processor (e.g., central processing unit (CPU)) can quickly read the data to be transferred from the faster memory when executing the transfer operation without having to wait for the data to be read from slower memory. Also, a minimum prefetch or preload offset may be employed with the prefetch or preload operation so that data read from slower memory and written to faster memory is completed before the CPU needs access to the data during the transfer operation.

In other disclosed embodiments, preload-related computations and operations are used to minimize overhead in setting up data transfers in data transfer software functions. For example, the data transfer software function may be included in software libraries that are called upon for data transfers. One non-limiting example of a data transfer software routine is a modified version of the “memcpy” software function in the C programming language. The use of preload-related computations and operations is designed to be dependent on the data transfer size. The use of preload-related computations and operations to provide efficient data transfers can vary depending on the data transfer size and other parameters of the CPU, including without limitation, the number of available internal registers, the size of the registers, and the line size of the memory.

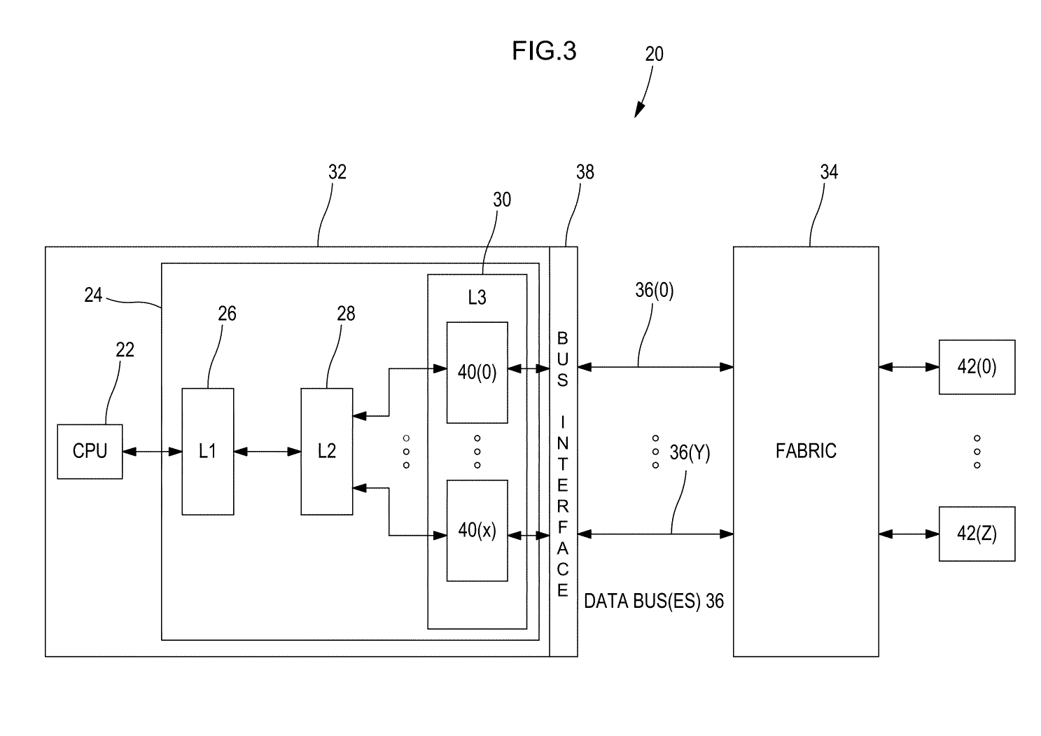

In this regard, FIG. 3 is a block diagram of an exemplary processor-based system 20 employing accelerated interleaved memory data transfers according to the embodiments disclosed herein. Before discussing the embodiments of accelerated interleaved memory data transfers, the processor-based system 20 is first discussed. The processor-based system 20 includes a central processing unit (CPU) 22 and cache memory 24. The cache memory 24 in this embodiment includes a first level cache memory (L1) 26, a second level cache memory (L2) 28, and a third level cache memory (L3) 30. In this embodiment, the CPU 22, the first level cache memory (L1) 26, the second level cache (L2) 28, and the third level cache memory (L3) 30 are included on the same semiconductor die 32. Memory read accesses by the CPU 22 are transferred from memories 42 from the fabric 34 over a data bus 36 to a bus interface 38 to the cache memory 24. Memory write accesses by the CPU 22 are transferred to the cache memory 24 to the bus interface 38 to the fabric 34 over a data bus 36 to memories 42.

With continuing reference to FIG. 3, the data received from the fabric 34 is first transferred into the third level cache memory (L3) 30, which is typically larger in size (e.g., 1 MegaByte (MB) to 20 MB) and has slower memory than the first level cache memory (L1) 26 (e.g., 32 KB) and second level cache memory (L2) 28 (e.g., 1 MB). For example, based on a reference to the CPU 22 pipeline clock where a CPU register access takes 1 clock, the latencies of the first level cache memory (L1) 26 and second level cache memory (L2) 28 are typically one (1) to ten (10) times slower, the third level cache memory (L3) 30 are typically ten (10) to fifty (50) times slower, and memories 42 are typically one hundred (100) to over one thousand (1000) times slower. Data can be transferred from the third level cache memory (L3) 30 and stored in the second level cache memory (L2) 28 and first level cache memory (L1) 26. In this embodiment, to provide for efficient data transfers, the third level cache memory (L3) 30 is configured as interleaved memory. In this regard, the third level cache memory (L3) 30 contains a plurality of memory banks 40(0)-40(X), wherein ‘X’ is an even whole positive number minus 1. The memory banks 40(0)-40(X) are configured as interleaved memory to allow concurrent reading and writing of data to and from the third level cache memory (L3) 30. As a non-limiting example, two memory banks 40 may be provided in the third level cache memory (L3) 30 that load or store interleaved one (1) KiloByte (KB) address blocks at one (1) KB boundaries.

With continuing reference to FIG. 3, a plurality of data buses 36(0)-36(Y) may be provided to transfer data between the fabric 34 and the bus interface 38 to further improve data transfer efficiency, where ‘Y’ is an even whole positive number minus 1. Also in this embodiment, to improve data transfer efficiency, a plurality of memory controllers 42(0)-42(Z) are provided and coupled to the fabric 34, wherein ‘Z’ is equal to a number of interleaved fabric memory banks (not shown). The memory controllers 42(0)-42(Z) are configured to interleave memory address blocks among the plurality of fabric memory banks. In this embodiment, two memory controllers 42 are provided and configured to access two interleaved fabric memory banks having the same address block size as used to interleave the memory banks 40 in the third level cache memory (L3) 30. Thus, the third level cache memory (L3) 30 can accept data transfers from the memory controllers 42 via the bus interface 38 at the same data transfer rate as provided by the memory controllers 42 to the fabric 34.

The data bus 36 may be provided as interleaved data buses 36(0)-36(Y) configured to carry data for interleaved memory address blocks according to the interleaving scheme provided by the memory controllers 42(0)-42(Z). Alternatively, a single data bus 36 can be provided to transfer data serially between interleaved memory address blocks from the memory controllers 42(0)-42(Z) and the bus interface 38.

Providing the interleaved third level cache memory (L3) 30 and interleaved memory controllers 42(0)-42(Z) can increase memory bandwidth available to the CPU 22 by a multiple of the number of unique interleaved memory banks, but only if interleaved third level cache memory (L3) 30 and interleaved memory controllers 42(0)-42(Z) handle data transfer operations without waits one hundred percent (100%) of the time. However, memory address alignments used by the CPU 22 may not often align with optimal interleaving address boundaries in the interleaved memory. This is because the address alignments used by the CPU 22 are typically created based on the alignments of the memory buffers (e.g., four (4) bytes) engaged by the CPU 22, and not the architecture of the interleaved memory. Further, data transfer sizes that are less than the stride of the interleaved memory may not benefit from the interleaved memory system. For example, the address alignments of two CPU 22 data transfer streams (e.g., a large block of sequentially addressed memory being read/written) will have approximately a three percent (3%) likelihood of being aligned in the same cache line in the opposite memory bank 40 having a one (1) KB interleaved address block size at 1 KB boundaries with sixty-four (64) byte line size (64 bytes/2 KB=3.1%) to fully utilize the interleaved third level cache memory (L3) 30 and memory controllers 42(0)-42(Z).

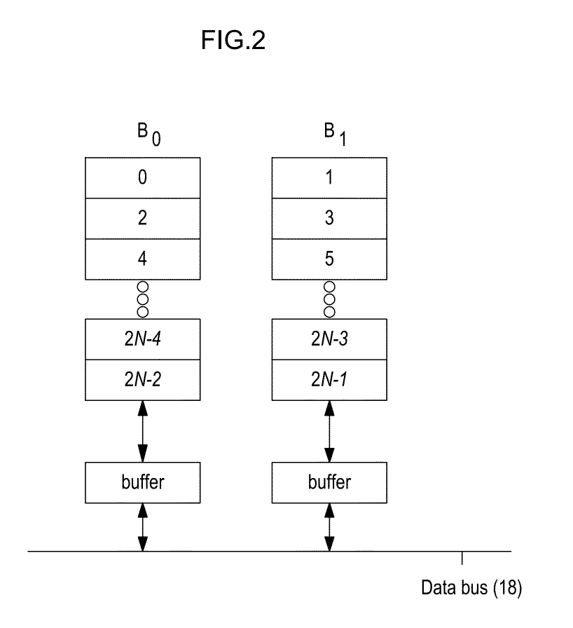

To efficiently utilize interleaved memory systems for accelerated data transfers, including those provided in the processor-based system 20 in FIG. 2, in certain disclosed embodiments, memory addresses for data stream operations are address aligned. The memory addresses for data stream operations are address aligned to not access the same memory bank in interleaved memory at the same time during the data transfer. For example, a memory address for a read data stream involved in a memory data transfer is address aligned so that the memory address for the read data stream and the memory address for a write data stream do not access the same memory bank in interleaved memory at the same time during the data transfer. Data transfer memory address alignment provides increased data transfer efficiency for large data transfers where the size of the data transfer is greater than the interleaved address block size.

To provide further increases in data transfer efficiency, the data to be transferred may also be prefetched or preloaded into faster memory (e.g., faster cache memory) before the transfer operation is executed. By prefetching or preloading, the CPU 22 can quickly read the data to be transferred from the faster memory when executing the transfer operation without having to wait for the data to be read from slower memory. The CPU 22 is typically pipelined such that multiple read and write operations (typically the size of a cache line) can be dispatched by the CPU 22 to memories without stalling the CPU 22 pipeline. Also, a minimum prefetch or preload offset may be employed with the prefetch or preload operation so that data read from slower memory and written to faster memory is completed before the CPU 22 needs access to the data during the transfer operation.

As an example, data stream address alignment of a 1 (one) KB interleaved address block size at 1 (one) KB boundaries (starting at memory address 0—e.g., boundaries 0x000, 0x400, 0x800, etc.) could be as follows. Consider a memory copy transfer (e.g., the memcpy C language function) where the least significant bits (LSBs) of the starting read memory address is x000 and the LSBs of the starting write memory address is x000. The third level cache memory (L3) 30 will be used by the CPU 22 to store read data for fast access when the read data is written during the data transfer operation. These read and write memory addresses will access the same memory bank 40 in the third level cache memory (L3) 30 during the data transfer. However, because the stride is 1 (one) KB, the starting read memory address could be set by the CPU 22 to 0x400 in the third level cache memory (L3) 30 for the memory reads and writes to be aligned for accessing different memory banks 40 during the data transfer. In this example, the starting read memory address could be set by the CPU 22 to also be 0xC00 in the third level cache memory (L3) 30 for the memory reads and writes to be aligned for accessing different memory banks 40 during the data transfer. In this example, the stride of the interleaved memory banks 40 controls the optimal alignment distance between the read memory address and the write memory address.

With continuing reference to FIG. 3, the architecture of the processor-based system 20 also allows for preload (PLD) software instructions to be executed by the CPU 22 for data transfers. Preloading can be used ahead of execution of a data transfer operation to start to read data from the starting read memory address so that the CPU 22 does not have to wait before writing the data to the write memory address when the data transfer operation is executed. In this regard, the processor-based system 20 in FIG. 3 allows for a preload (PLD) instruction. A preload is an asynchronous memory read operation that the CPU 22 can issue to request/read “future data” from slower memory (e.g., fabric memory) into the faster caches (e.g., the third level cache memory (L3) 30).

A preload operation is deemed to be an asynchronous operation in this example, because the CPU 22 does not wait for the result of a preload operation. At a later time, the CPU 22 uses a synchronous load/move instruction to read the “current data” from the faster cache (e.g., the third level cache memory (L3) 30) into a CPU 22 register. If a PLD instruction is issued far enough ahead of time, the read latency of the slower memory (e.g., the fabric memory) can be hidden from the CPU 22 pipeline such that the CPU 22 only incurs the latency of the faster cache memory access (e.g., the third level cache memory (L3) 30). Given a sequential stream of addresses, the term “minimum preload offset” is used to describe how many addresses ahead of the current read pointer to preload read data in order to be far enough ahead to overcome the read latency of the slower memory. In this example, the cache memory 26, 28, 30 in which the preloaded data from the fabric memory is loaded can be specified as desired.

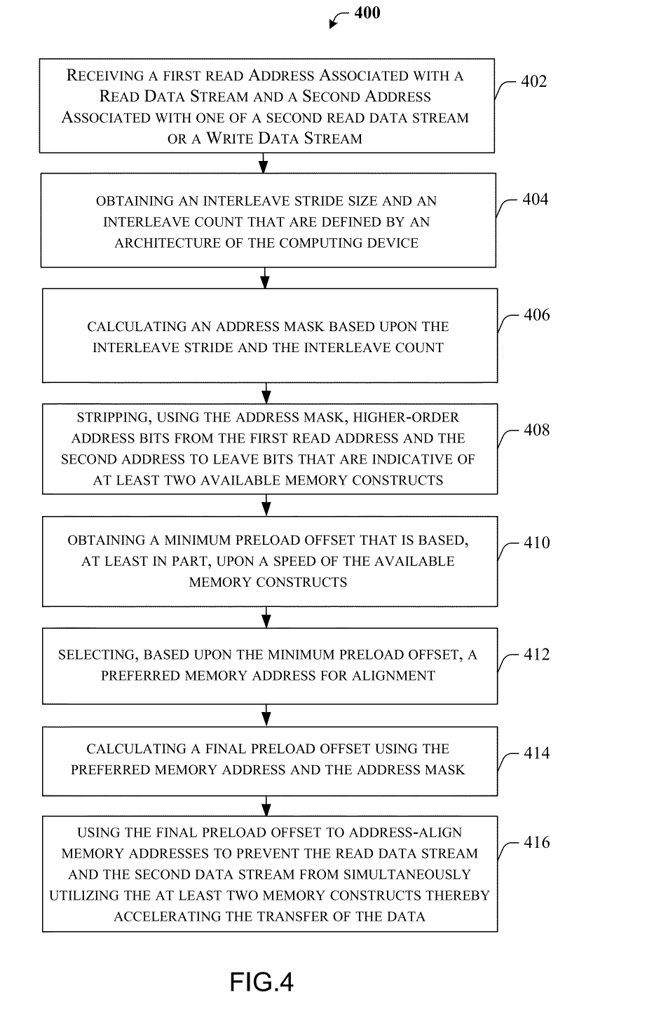

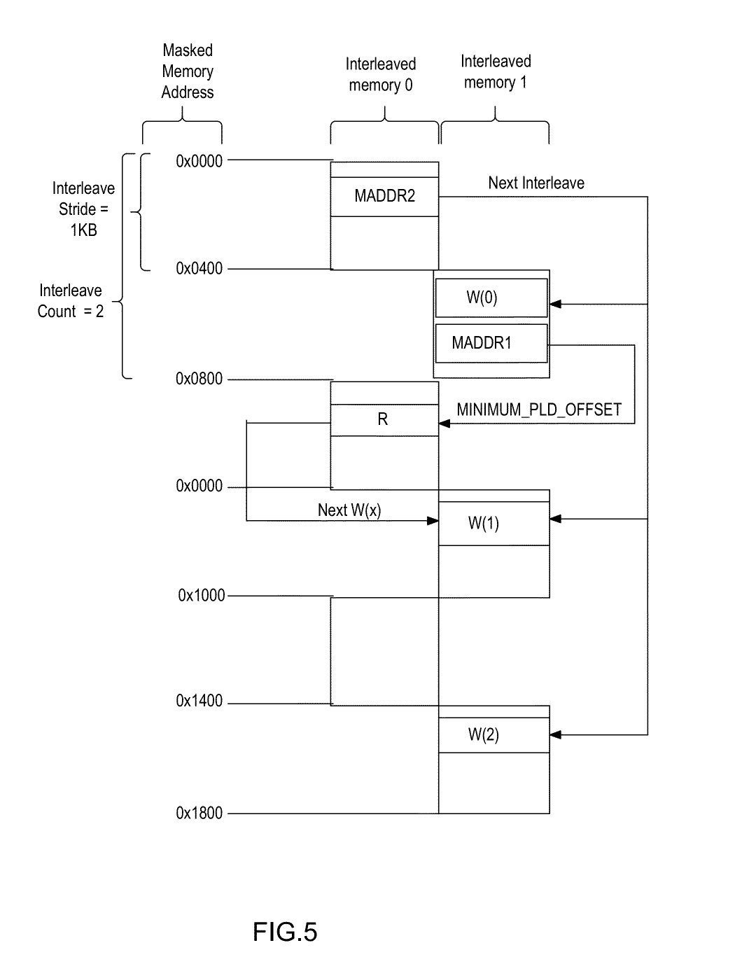

FIG. 4 is a flowchart that illustrates a method for determining memory address alignment for accelerated data transfers involving interleaved memory to further explain the embodiments described herein by example. While referring to FIG. 4, simultaneous reference is made to FIG. 5, which is a block diagram depicting memory address alignment in connection with two memory constructs, but the method depicted in FIG. 4 is certainly not limited to two memory constructs.

As depicted in FIG. 4, a first read address associated with a read data stream is received and a second address associated with one of a read data stream or a write data stream is received (Block 402). In the example depicted in FIG. 5, the first memory address is shown as “addr1” and the second memory address is shown as “addr2.” The first memory address (addr1) input is an address that is being read using a streaming operation. A preload offset (PLD_OFFSET) is calculated such that a preload to the first memory address (addr1+PLD_OFFSET) will address a different interleaved memory bank than a read or write to the second memory address (addr2).

With continuing reference to FIG. 4, an interleave stride size and an interleave count are obtained, which are defined by the architecture of the computing device (Block 404). The interleave stride (INTERLEAVE_STRIDE) of the processor-based system architecture defines how memory address blocks map to unique memory constructs (e.g., memory banks or devices). As one of ordinary skill in the art will appreciate, the interleave stride is a hardware specific aspect that is specific to the type of hardware in the computing device. In FIG. 5, an interleave stride (INTERLEAVE_STRIDE) of one (1) KB is used as an example, but other interleave stride sizes are certainly contemplated. The interleave count (INTERLEAVE_COUNT) is also hardware specific and is defined by the processor-based system architecture, which equals the number of unique memory banks or devices assigned to the memory address interleave strides (INTERLEAVE_STRIDE). In FIG. 5, an interleave count (INTERLEAVE_COUNT) of two (2) is used merely as an example, but interleaving counts that exceed two are certainly contemplated.

With continuing reference to FIG. 4, an address mask (ADDRESS_MASK) is calculated based upon the interleave stride and the interleave count (Block 406), and the higher-order address bits are stripped from the first read address and the second address to leave bits that are indicative of at least two available memory constructs (Block 408). For example, the address mask may be bitwise ANDed to the first memory address (addr1) and the second memory address (addr2) such that only the lower address bits are used for address alignment calculations. The result of this calculation will be referred to as a “masked” address and is shown in FIG. 5 as the first masked address (MADDR1) and the second masked address (MADDR2). The address mask (ADDRESS_MASK) formula is as follows:

ADDRESS_MASK=((INTERLEAVE_COUNT*INTERLEAVE_STRIDE*2)−1)

MADDR1=(ADDRESS_MASK “AND” addr1)

MADDR2=(ADDRESS_MASK “AND” addr2)

With continuing reference to FIG. 4, a minimum preload address is obtained that is based, at least in part, upon a speed of the available memory constructs (Block 410). More specifically, there is a minimum PLD offset (MINIMUM_PLD_OFFSET) such that executing a preload to a minimum PLD address (addr1+MINIMUM_PLD_OFFSET) insures that the preload data arrives in the targeted cache (e.g., third level cache memory (L3) 30) before the CPU 22 reads the data. The minimum preload offset (MINIMUM_PLD_OFFSET) is the minimum number of sequential addresses in advance that a preload instruction must be issued in order for data to arrive in the faster caches before CPU 22 access.

The calculated PLD (PLD_OFFSET) must always be greater than or equal to the minimum PLD offset (MINIMUM_PLD_OFFSET). The minimum PLD address is labeled “R” in FIG. 5. The minimum PLD address is calculated as follows:

R=MADDR1+MINIMUM_PLD_OFFSET

With continuing reference to FIG. 4, based upon the minimum preload offset, a preferred memory address is selected for alignment (Block 412). As shown in FIG. 5, for any second masked address (MADDR2), there are three (3) memory addresses in the next adjacent interleaved memory bank or device that are potential memory addresses to calculate the preload offset (PLD_OFFSET). Only one of these three (3) memory addresses will satisfy all the requirements. These three (3) memory addresses are shown and labeled in FIG. 5 as W(0), W(1), and W(2). The formulas to calculate these three (3) memory addresses W(0), W(1), and W(2) are as follows:

W(0)=MADDR2+INTERLEAVE_STRIDE

W(1)=W(0)+(INTERLEAVE_COUNT*INTERLEAVE_STRIDE)

W(2)=W(1)+(INTERLEAVE_COUNT*INTERLEAVE_STRIDE)

To select the preferred memory address for alignment, the equation below may be used to identify a preferred memory address (PA):

If (R<=W(0) then PA=W(0)

Else If (R<=W(1) then PA=W(1)

Else PA=W(2)

As shown in FIG. 4, a final preload offset is calculated using the preferred memory address (PA) and the masked address 1 (MADDR1) (Block 414). For example, the calculated preload offset is calculated as:

PLD_OFFSET=PA−MADDR1

It is desirable that the calculated preload offset (PLD_OFFSET) should be as small as possible. This is because the PLD_OFFSET determines the efficiency of several embodiments of the invention at the beginning and end of an interleaved acceleration as well as the minimum size of the streaming operation to which several embodiments of this invention can be applied. For example, the PLD_OFFSET of many these embodiments this invention will always be less than or equal to:

((INTERLEAVE_STRIDE_COUNT*INTERLEAVE_STRIDE)+MINIMUM_PLD_OFFSET).

As a result, the preload offset (PLD_OFFSET) is calculated such that a preload to the first memory address (addr1+PLD_OFFSET) will address the closet preload address which is also in a different interleaved memory bank than a read or write to the second memory address (addr2); thus an efficient and usable data transfer is provided from interleaved memory. This efficiency determines the minimum address block size (MINIMUM_BLOCK_SIZE) of the data streaming operation on which many embodiments can be applied. It may also be desired that the first memory address (addr1) preloads do not extend past the end of the first memory address (addr1) stream to avoid inefficiencies. Therefore, it may be desired to minimize the preload offset (PLD_OFFSET) for smaller data transfer sizes. Also, it may be desired to start preloading data for a data transfer as soon as possible. If the preload offset (PLD_OFFSET) is larger than the calculation in FIG. 4, block 414, there will be inefficiencies at the beginning of the first memory address (addr1) preload stream where no data has been preloaded, or data has been preloaded without regard to the interleaved memories.

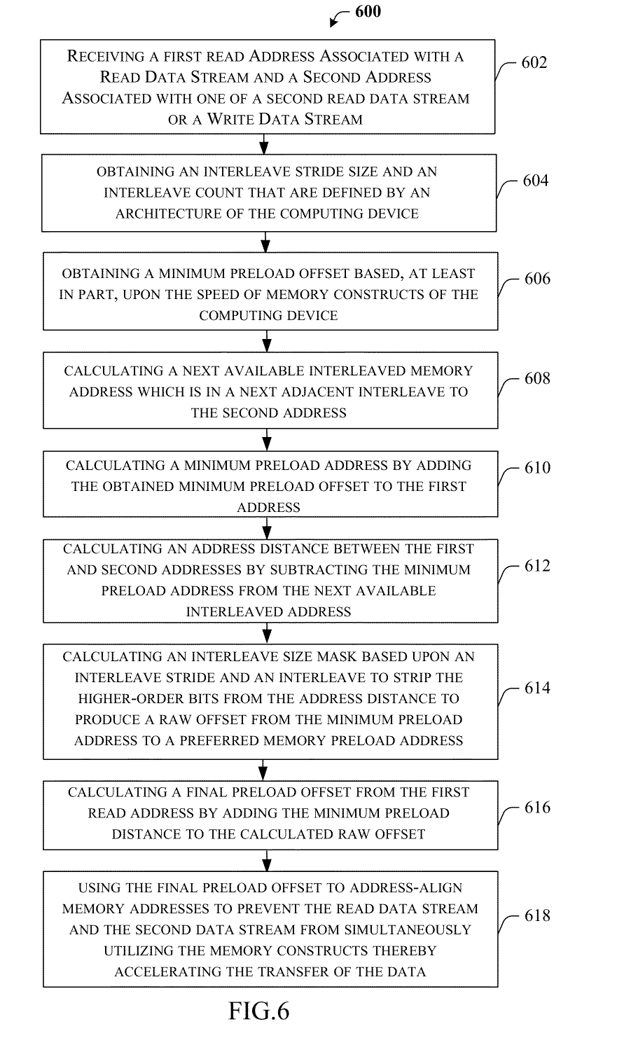

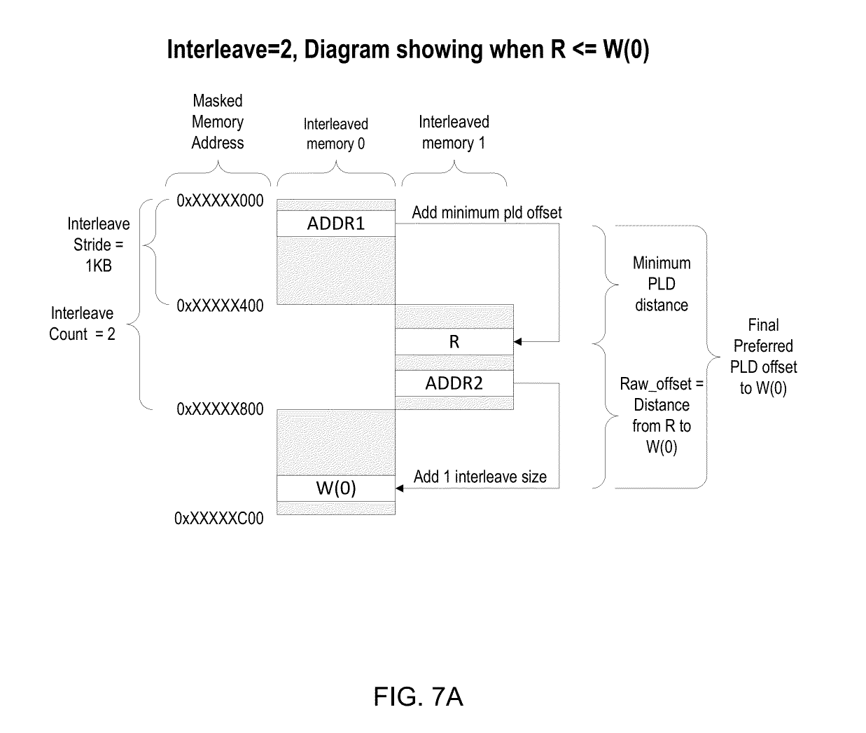

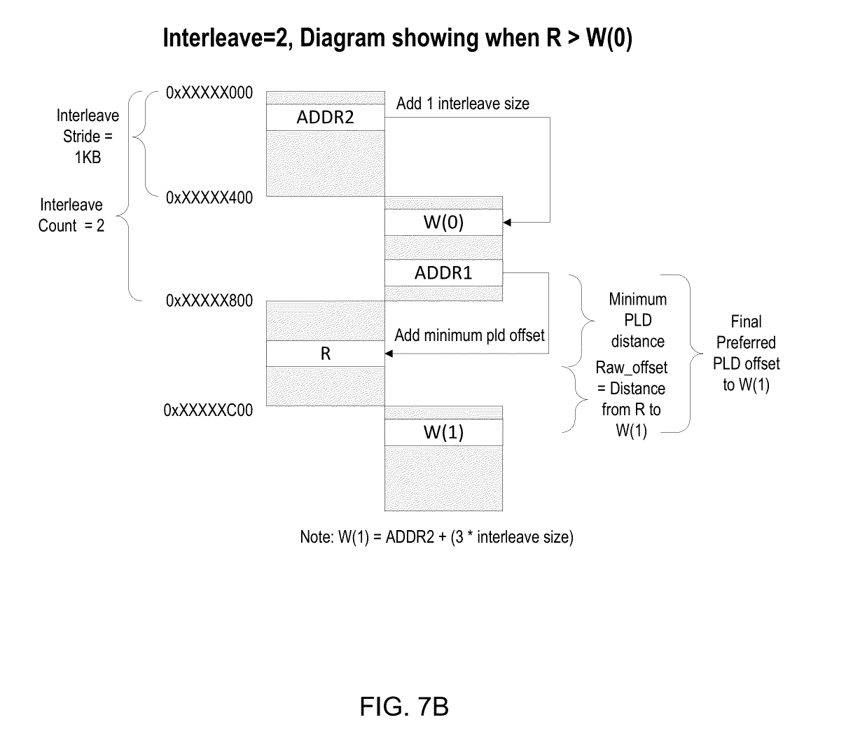

FIG. 6 is a flowchart that illustrates an optimized method for determining memory address alignment for accelerated data transfers involving only two interleaved memories to further explain the embodiments described herein by example. While referring to FIG. 6, simultaneous reference is made to FIGS. 7A and 7B, which are block diagrams depicting memory address alignment in connection with two memory constructs. The method depicted in FIG. 6 is optimized for two memory constructs but is certainly not limited to only two memory constructs.

As depicted in FIG. 6, a first read address associated with a read data stream is received and a second address associated with one of a read data stream or a write data stream is received (Block 602). In the example depicted in FIGS. 7A and 7B, the first memory address is shown as “addr1” and the second memory address is shown as “addr2.” The first memory address (addr1) input is an address that is being read using a streaming operation. A preload offset (PLD_OFFSET) is calculated such that a preload to the first memory address (addr1+PLD_OFFSET) will address a different interleaved memory bank than a read or write to the second memory address (addr2).

With continuing reference to FIG. 6, an interleave stride size and an interleave count are obtained, which are defined by the architecture of the computing device (Block 604). The interleave stride (INTERLEAVE_STRIDE) of the processor-based system architecture defines how memory address blocks map to unique memory constructs (e.g., memory banks or devices). As one of ordinary skill in the art will appreciate, the interleave stride is a hardware specific aspect that is specific to the type of hardware in the mobile computing device. In FIGS. 7A and 7B, an interleave stride (INTERLEAVE_STRIDE) of one (1) KB is used as an example, but other interleave stride sizes are certainly contemplated. The interleave count (INTERLEAVE_COUNT) is also hardware specific and is defined by the processor-based system architecture, which equals the number of unique memory banks or devices assigned to the memory address interleave strides (INTERLEAVE_STRIDE). In FIGS. 7A and 7B, an interleave count (INTERLEAVE_COUNT) of two (2) is used merely as an example, but interleaving counts that exceed two are certainly contemplated.

With continuing reference to FIG. 6, a minimum preload address is obtained that is based, at least in part, upon a speed of the available memory constructs (Block 606). More specifically, there is a minimum PLD offset (MINIMUM_PLD_OFFSET) such that when CPU 22 is reading a sequential address stream, the execution of a preload to a minimum PLD address (addr1+MINIMUM_PLD_OFFSET) insures that the preload data arrives in the targeted cache (e.g., third level cache memory (L3) 30) before the CPU 22 reads the data.

With continuing reference to FIG. 6, a next available interleaved memory address is calculated (Block 608). It is desirable that the preload address is in an adjacent interleave to the second address (addr2) and that the address distance between the preload address and the second address (addr2) is a multiple of the interleave stride to prevent the preload data stream and the second address stream (addr2) from simultaneously utilizing the same memory construct. For any second address (addr2), there are at least two adjacent interleaved memory bank or device addresses meeting these requirements. These two (2) memory addresses are shown in FIGS. 7A and 7B and labeled as “W(0)” and “W(1).” In this embodiment, only W(0) is required for the calculation of the preferred preload offset (PLD_OFFSET). The W(1) formula is provided as a reference to help with the description of this embodiment. The formulas to calculate these two (2) memory addresses W(0) and W(1) are as follows:

W(0)=ADDR2+INTERLEAVE_STRIDE

W(1)=ADDR2+((INTERLEAVE_COUNT+1)*INTERLEAVE_STRIDE))

With continuing reference to FIG. 6, the calculated final PLD_OFFSET must always be greater than or equal to the obtained minimum PLD offset. To guarantee this rule is met, a minimum preload address is calculated by adding the obtained MINIMUM_PRELOAD_OFFSET to the first address (addr1) (Block 610). The minimum preload address is shown in FIGS. 7A and 7B as label “R” and is calculated with the formula:

R=ADDR1+MINIMUM_PLD_OFFSET

With continuing reference to FIG. 6, an address distance (in units of bytes) between the minimum preload address “R” and the next adjacent interleave address “W(0)” is calculated by subtracting “R” from “W(0)” (Block 612). The address distance is shown in FIGS. 7A and 7B as label “D” and has the formula:

D=W(0)−R

As one skilled in the art can appreciate, the modulo of a positive number is a well-defined mathematical operation and is represented by the “%” symbol. However, the modulo of a negative number is not explicitly defined and varies with the hardware or software implementation. A “bitwise AND” is also a well-known logical operation and is represented by the “&” symbol. The term modulo is used to describe a concept of embodiments described herein, but since a bitwise AND is actually used in the calculation, the expected results using either a positive or negative number are well defined.

It should be noted that the high order bits of both of the above “W(0)” and “R” addresses are unknown and therefore it is unknown whether the result “D” is positive or negative, large or small. This is resolved by using the remainder from a type of modulo operation. The modulo of “powers of 2” can be quickly calculated by using a bitwise “AND” and can alternately be expressed as:

X%2ⁿ==X&(2ⁿ−1)

Typically, only positive values of X are used in modulo equations; however embodiments will use the function with both positive and negative values in order to optimize the number of required steps. In the equation above, the “(2′-1)” component of the above equation will be referred to as the “INTERLEAVE_SIZE_MASK.”

As is well known, the CPU 22 stores negative numbers in a “2's complement” format which uses the highest order bit to represent a negative number. In several embodiments, the highest order bit of the INTERLEAVE_SIZE_MASK will always be 0. Therefore a bitwise “AND” using the INTERLEAVE_SIZE_MASK will apply both a modulo and an absolute value function to “X.” Besides the modulo and absolute functions, a third property of the computing system is used by the bitwise “AND.” As stated, negative numbers are stored in a 2's complement format. Using a 32-bit CPU 22 as an example, a negative number such as “−X” would be stored in a register as (2³²−X). When a bitwise “AND” of the INTERLEAVE_SIZE_MASK of (2ⁿ−1) is applied to a 2's complement number such as “X,” it will produce a modulo remainder equal to the absolute value (2ⁿ−X). When it is applied to a positive number, it will produce a modulo remainder equal to “X.”

With continuing reference to FIG. 6, an INTERLEAVE_SIZE_MASK is calculated based upon the interleave stride and the interleave count (Block 614). This mask is then applied to the address distance “D” using a bitwise “AND.” Using the properties of the bitwise “AND” as explained above, a raw offset (RAW_OFFSET) is calculated. Referring to FIG. 7A, if the distance “D” was a positive number, then the raw offset will be the distance from “R” to “W(0).” Referring to FIG. 7B, if the distance “D” was a negative number, then the raw offset will be the distance from “R” to “W(1).”

The formulas used in Block 614 can be expressed as:

INTERLEAVE_SIZE_MASK=((INTERLEAVE_COUNT*INTERLEAVE_STRIDE)−1)

RAW_OFFSET=D & INTERLEAVE_SIZE_MASK

With continuing reference to FIG. 6, a final preload offset (PLD_OFFSET) is calculated by adding the MINIMUM_PRELOAD_OFFSET to the RAW_OFFSET from block 614 (Block 616). The formula used can be expressed as:

PLD_OFFSET=RAW_OFFSET+MINIMUM_PRELOAD_OFFSET

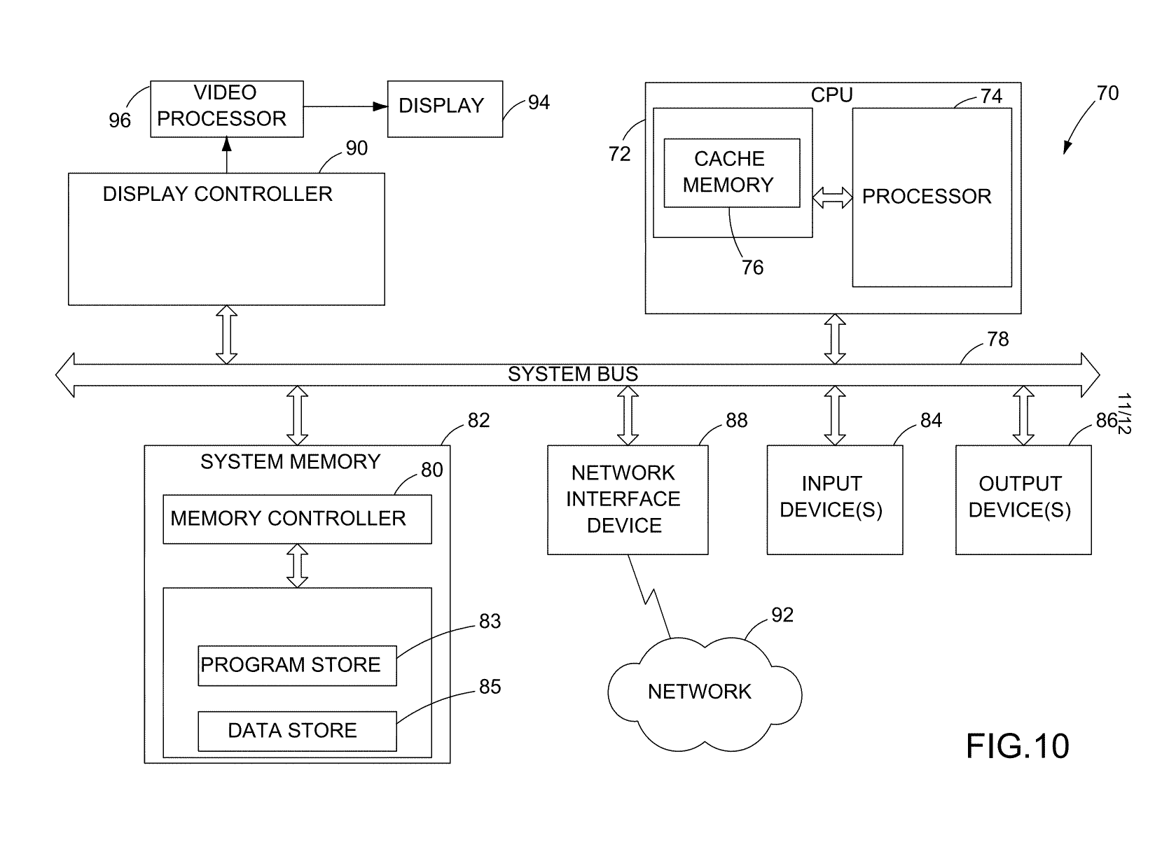

With continuing reference to FIG. 6, the preload offset (PLD_OFFSET) is calculated such that a preload to the first memory address (addr1+PLD_OFFSET) will address a different interleaved memory bank than a read or write to the second memory address (addr2); thus an efficient and usable data transfer is provided from interleaved memory. This efficiency determines the minimum address block size (MINIMUM_BLOCK_SIZE) of the data streaming operation. It also may be desired that that the first memory address (addr1) preloads do not extend past the end of the first memory address (addr1) stream to avoid inefficiencies. Therefore, it may be desired to minimize the preload offset (PLD_OFFSET) for smaller data transfer sizes. Also, it may be desired to start preloading data for a data transfer as soon as possible. If the preload offset (PLD_OFFSET) is larger than the calculation in block 616, there will be inefficiencies at the beginning of the first memory address (addr1) preload stream where no data has been preloaded. It is also contemplated that the software flowchart from FIG. 6 could be built into the hardware of processor 74 shown in FIG. 10. Whereas the software implementations require a user to add the necessary methods to every software routine that is to be accelerated, a hardware embodiment could implement the methodologies disclosed herein in a more automated fashion. This type of logic is known as a hardware prefetcher.

Many types of hardware prefetchers are in existence in hardware, but embodiments disclosed herein implement novel and unique algorithms, which have not previously been used in any hardware. The typical hardware prefetchers search for a recognized pattern of read data and then automatically begin to speculatively preload future data based on the current read pattern. Typical examples of prefetch algorithms are an instruction or data cache fill that will cause the next cache line to be prefetched. A strided data prefetcher will look for a constant address stride between several data reads. It then uses that constant stride and multiplies by a predetermined count to create a prefetch address that it speculates that the CPU will read in the future. The automatic strided prefetch operation stops when the read address stride is broken. The common theory of these existing prefetchers is to prefetch data based on a single stream of reads. They do not take interleaved memory devices or a second data stream into account.

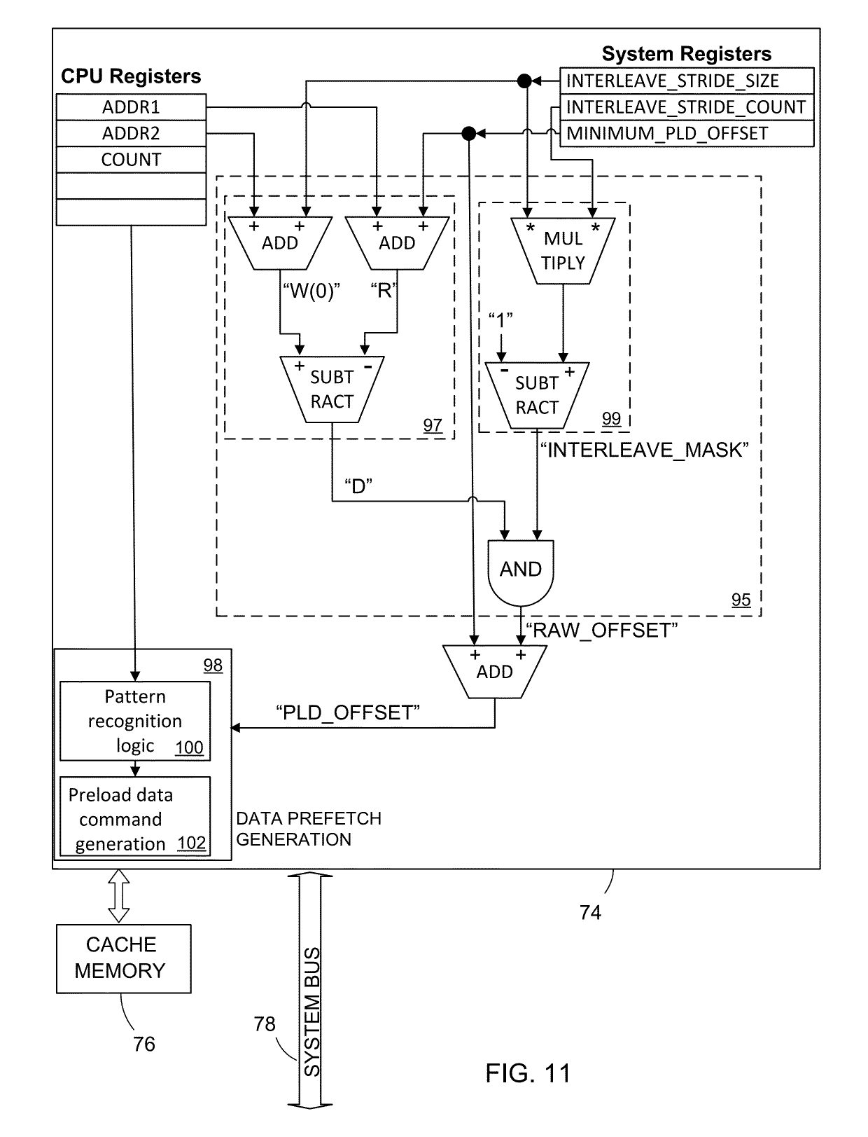

FIG. 11 is an exemplary diagram depicting a hardware embodiment. The flowchart in FIG. 6 can be directly applied to the hardware logic in FIG. 11. In the flowchart, block 602 receives a first read address and a second read or write address from software, whereas the hardware of CPU 74 will receive this data in the CPU registers (shown as addr1 and addr2). The software implementation of flowchart blocks 604 and 606 obtain the INTERLEAVE_STRIDE_SIZE, INTERLEAVE_STRIDE_COUNT, and MINIMUM_PLD_OFFSET, whereas the depicted hardware system registers could be used to store these values.

Flowchart blocks 608, 610, 612, 614, and 616 are used to calculate the final PLD_OFFSET. Using the formulas from the flowchart description above, the hardware, as shown in FIG. 11, can implement the exact same equations using a combination of add, subtract, multiply, and bitwise AND logic blocks to calculate R, W(0), INTERLEAVE_MASK, D, RAW_OFFSET, and the final PLD_OFFSET. As shown, a collection of raw offset logic blocks 95 (including raw address distance logic 97 and interleave mask logic 99) generates a raw offset that is added to the minimum preload offset to obtain a final offset (PLD_OFFSET). The final offset PLD_OFFSET in this embodiment is connected into a data prefetch generation component 98, which includes a pattern recognition logic 100 and preload data command generation logic 102. As shown, the pattern recognition logic 100 may also receive data from the CPU registers to aid in the pattern recognition. Alternately (or in addition to the hardware implemented pattern recognition logic 100), a software hint could be added to the instruction set, thereby allowing software to directly enable the hardware implementation. After receiving a software hint or recognizing a pattern, which can be hardware accelerated by embodiments of this invention, the preload data command generation logic 102 will do the equivalent function as block 618 where the logic adds the final PLD_OFFSET to addr1 and issues a data preload command to the memories.

There are also a number of hints that can be specified with each data PLD instruction. The use of software hints with regards to reading and writing cache data are known in the art. These hints are not required by the either the software or hardware embodiment, but some of these software hints could be extended or new ones created to also apply to this embodiment. For example, one hint is whether data is to be streamed or not. Streaming data is transient and temporal and may not be expected to be needed again. Thus, streamed data may be removed from cache memory as soon as it is loaded by the CPU. This may make some data streaming operations more efficient by reducing cache use. Another hint is whether data is expected to be read and/or written in the future. These hints can be combined. Also, some or all of these hints may or may not be available depending on the type of CPU chip employed.

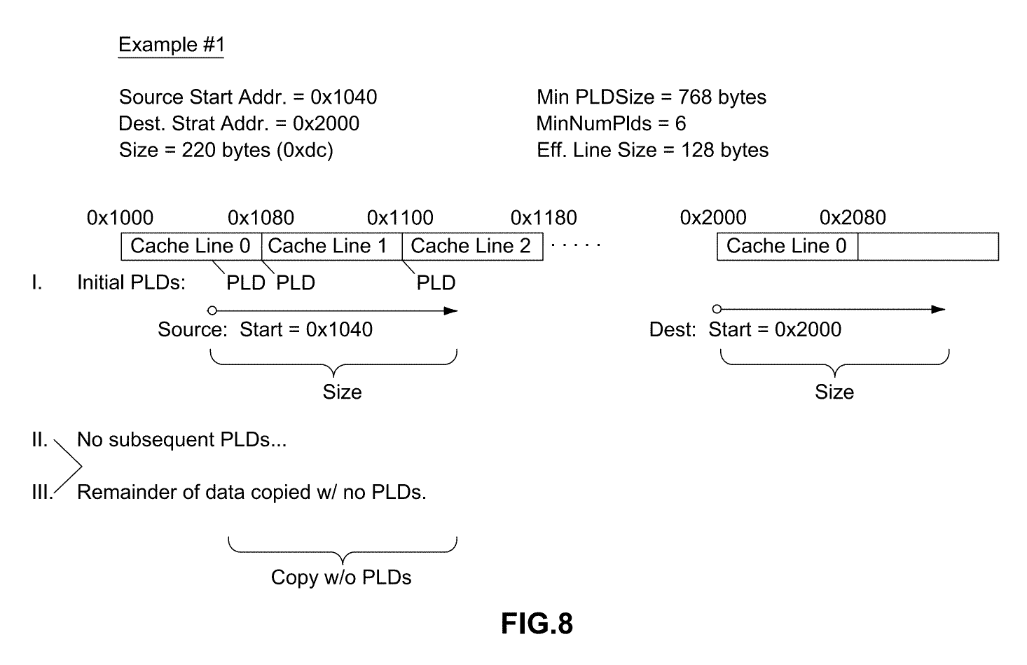

In this regard, FIG. 8 illustrates an example of a smaller data transfer, which may be effectuated in connection with embodiments disclosed herein. Although certainly not required, a memcpy C language function may be modified consistent with the methodologies disclosed herein to provide the depicted data transfer functionality. The embodiments disclosed above can be employed for this data transfer depending on the minimum address block size (MINIMUM_BLOCK_SIZE). Other embodiments disclosed and discussed in more detail below can also alternatively be employed if the data transfer size is smaller than the minimum address block size (MINIMUM_BLOCK_SIZE) With reference to FIG. 8, in this example, the source starting address is 0x1040. The destination starting address is 0x2000. The copy size is 220 bytes (i.e. 0xDC bytes). The minimum preload size (MinPLDSize) is 768 bytes. The minimum number of PLDs (MinNumPLDs) is six (6). The cache line size is 128 bytes, meaning that 6 caches lines are to be preloaded before the CPU writes the read memory data. The initial PLD retrieves the first cache line 0 from the starting source address and preloads the first cache line 0 into cache memory at memory address 0x1000 to address align the source preload address on a cache line address boundary before the data transfer operation is performed, as previously discussed above (Section I in FIG. 8). Cache lines 1 through 5 are then preloaded contiguously until six cache lines starting at the source memory address are preloaded into cache memory (Section I in FIG. 8). No subsequent preloads are performed, because the copy size is less than the minimum preload size (MinPLDSize) (Section II in FIG. 8). The CPU then copies the read data preloaded into cache memory to the destination memory address starting at 0x2000 (Section III in FIG. 8).

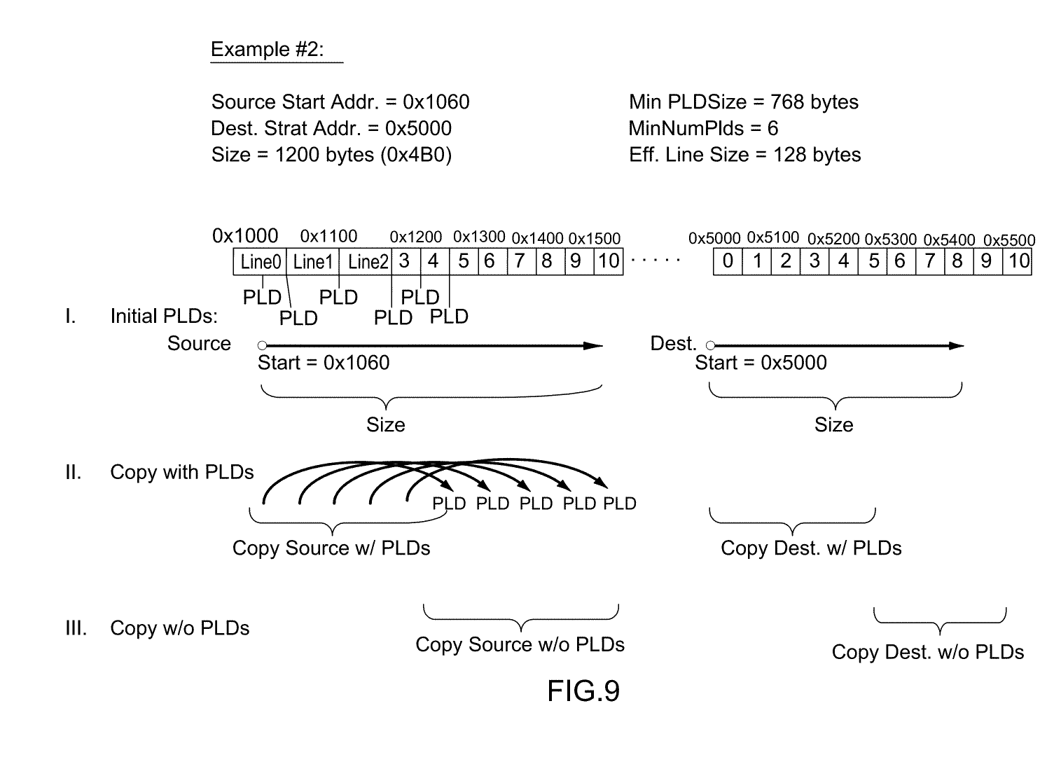

FIG. 9 illustrates another example of a smaller data transfer, which may be effectuated in connection with embodiments disclosed herein. In this example, the source starting address is 0x1060. The destination starting address is 0x5000. The copy size is 1200 bytes (i.e. 0x4B0 bytes). The minimum preload size (MinPLDSize) is 768 bytes. The minimum number of PLDs (MinNumPLDs) is six (6). The cache line size is 128 bytes, meaning that 6 caches lines are to be preloaded before the CPU writes the read memory data. The initial PLD retrieves the first cache line 0 from the starting source address and preloads the first cache line 0 into cache memory at memory address 0x1000 to address align the source preload address on a cache line address boundary before the data transfer operation is performed, as previously discussed above (Section I in FIG. 9). Cache lines 1 through 5 are then preloaded contiguously until six cache lines starting at the source memory address are preloaded into cache memory (Section I in FIG. 9). The CPU then copies the read data preloaded into cache memory to the destination memory address, which starts at 0x5000. Preloads continue during data transfer until the last cache line in the read data is preloaded into cache memory according to the copy size (Section II in FIG. 9). The CPU then finishes the copy of the read data to the destination until all cache line data has been copied without further preloading for the last six cache lines (the minimum preload size (MinPLDSize) (Section III in FIG. 9)).

There are different approaches that can be used to calculate the preload offset (PLD_OFFSET). Below are three (3) examples that follow the steps outlined above with reference to FIG. 4 that are written in C language code format. Each example employs slightly different calculations. These examples are based on using a processor-based system with the following parameters:

INTERLEAVE_STRIDE=1024 bytes

INTERLEAVE_STRIDE_COUNT=2

### Example 1

### Calculating the Preferred Preload Offset

int get_pld_address1(char *addr2, char *addr1, int pld)
{
int w, r, d, x;

| | |
|---|---|
| addr1 += pld; | //Add in the minimum pld offset |
| w = (int)addr2 & 0x0FFF; | //Only look at 4K offset |
| r = (int)addr1 & 0x0FFF; | |
| r += 0x1000; | //Make sure R is larger so we don't have to |
| | deal with negative numbers. |
| d = r − w; | |
| if (0 == (d & 0x0400)) | //Decide whether to bump up an extra 1K |
| | to get past the current 1K write block. |
| x = 0x0400; | |
| else | |
| x = 0x0C00; | |
| d = d & 0x7FF; | // Get rid of the extra 4K if it was added in |
| | (ie x=0x0C00) |
| x −= d; | |
| x += pld; | |
| return(x); | |
| } | |

### Example 2

### Calculating the Preferred Preload Offset

int get_pld_address2(char *addr2, char *addr1, int pld)
{
int w, r, d;

| | |
|---|---|
| w = ((int)addr2 + 0x400); | //Point to opposite bank. |
| r = ((int)addr1 + pld); | //Add minimum PLD distance |
| w &= 0x07FF; | //Point to lower 2K before comparing |
| r &= 0x0FFF; | //Limit to a 4K block. |
| if (w < r) | //If w >= r already, do nothing as w |
| | pointer is already ahead of r. |
| w += 0x0800; | // else bump up to the next opposite bank. |
| if (w < r) | //If w >= r already, do nothing as w |
| | pointer is already ahead of r. |
| w += 0x0800; | // else bump up to the next opposite bank. |

// W is now guaranteed to be >= R

| | |
|---|---|
| d = w − r; | //Get distance from r |
| d += pld; | //Add pld back to get distance from original |
| | addr1 |
| return(d1); | |
| } | |

### Example 3

### Calculating the Preferred Preload Offset

int get_pld_address3(char *addr2, char *addr1, int min_pld)
{
int w, r, d;

| | |
|---|---|
| w = ((int)addr2 + 0x400); | //Point to opposite bank. |
| r = ((int)addr1 + min_pld); | //Add minimum PLD distance |

| | |
|---|---|
| w &= 0x0FFF; | //Limit to a 4K block. |
| r &= 0x0FFF; | //Limit to a 4K block. |
| d = w − r; | //Get distance from r |
| if (d < 0) | |
| { | |
| d = 0x1000 + d; | //if negative, add 4K to go to next 4K block. |
| } | |
| d = d & 0x07FF; | //Clear bit(11) so distance is less |
| | than or equal to 2K |
| d += min_pld; | //Add pld back to get distance from |
| | original addr1 |
| return(d1); | |
| } | |

There are several architecture design choices that can influence the calculations described herein. The list below in Example 4 illustrates some of these dependencies.

### Example 4

### System Design Parameters

//PLD_SIZE = Number of bytes which are read by a Preload
data command. System specific.
#define PLD_SIZE (64)
//MIN_PLD_OFFSET = How far ahead PLD commands
need to execute so data is read into a cache
// before the CPU is ready to use it. Varies based on system
memory latency.
#define MIN_PLD_OFFSET (6 * PLD_SIZE)
//INTERLEAVE_STRIDE = Size of the address block associated
with each interleaved memory device.
// This is hardware specific.
#define INTERLEAVE_STRIDE (1024)
//MIN_BLOCK_SIZE = Minimum number of bytes required
// Although (4* INTERLEAVE_STRIDE) is the minimum,
// it is a typical to use a higher number as there is overhead
// in using embodiments disclosed herein.
#define MIN_BLOCK_SIZE (8 * INTERLEAVE_STRIDE)

Below are two further examples of how data transfer memory address alignment can be provided for write and read data streams. Example 5 below illustrates when the first memory address (addr1) is a read stream and the second memory address (addr2) is a write stream. Example 6 below illustrates when the first memory address (addr1) is a read stream and the second memory address (addr2) is a read stream.

### Example 5

### Using Two Data Streams, where Addr1=Read, Addr2=Write

```
analyze_memory_rd_wr_data(char *addr2,  // addr
            of the 2nd stream (write stream) char *addr1,  // addr
            of the 1st stream (Always a read stream) int size)
{
int pld_offset;
int i, j;
int temp1, temp2;
if (size < MIN_BLOCK_SIZE)
{
  //Use a default value if the size is not large enough.
  pld_offset = MIN_PLD_OFFSET;
}
else
{
  //Invoke the invention to get the preferred pld offset to accelerate data.
  pld_offset = get_pld_address1(addr2, addr1, MIN_PLD_OFFSET);
}
//Example of two data streams, where addr1=read, addr2=write
//Analyze two data streams, PLD_SIZE bytes at a time.
for (i=0; i < size; i=i+PLD_SIZE)
{
  // Request that future data is read into the cache using a preload type
  command Preload_data(addr1 + pld_offset);
  // Operate on the current data in the cache while the future data is
being preloaded from memory.
  // The current “temp” read data below comes from a high speed cache.
  // The current “temp” write data below will be written to an
  // interleaved memory while the Preload_data above is being
  // read from the opposite interleaved memory.
  for (j=0; j<PLD_SIZE; j++)
  {
  temp1 = *(addr1 + j)  //Read temp1 data from the addr1 stream.
  temp2 = func(temp1);  //Compute new temp2 data using some
  type of function
  *(addr2 + j) = temp2;  //Write new temp2 data to the addr2 stream;
  }
}
}
```

### Example 6

### Using Two Data Streams, where Both Streams are Reads

```
int analyze_memory_rd_rd_data(char *addr2,  // addr of the 2nd
          stream (read stream) char *addr1,  // addr of the 1st stream
          (always a read stream) int size)
{
int pld_offset;
int i, j;
int temp1, temp2;
int result;
if (size < MIN_BLOCK_SIZE)
{
  //Use a default value if the size is not large enough.
  pld_offset = MIN_PLD_OFFSET;
}
else
{
  //Invoke the invention to get the preferred pld offset to accelerate data.
  //Since both streams are read streams, addr2 is incremented by
  // the MIN_PLD_OFFSET before calculating the
  preferred pld_offset for addr1
  pld_offset = get_pld_address1((addr2+MIN_PLD_OFFSET),
  addr1, MIN_PLD_OFFSET);
}
//Example of two data streams, where addr1=read, addr2=write
//Analyze two data streams, PLD_SIZE bytes at a time.
for (i=0; i < size; i=i+PLD_SIZE)
{
  // Request that future data for both streams are read into the cache
using a preload type command
  Preload_data(addr1 + pld_offset);
  Preload_data(addr2 + MIN_PLD_OFFSET);
  // Operate on the current data in the cache while the future data
is being preloaded from memory.
  // The current “temp1” read data below comes from a high speed cache.
  // The current “temp2” read data below comes from a high speed cache.
  for (j=0; j<PLD_SIZE; j++)
  {
  temp1 = addr1[j];  //Read temp1 data from the addr1 stream.
  temp2 = addr2[j]  //Read temp2 data from the addr2 stream.
  result = func(temp1, temp2); //Compute result data using some
  type of function
  }
}
return(result)
}
```

It should be noted that the order of the operations in the examples above can vary for different implementations. It is not uncommon for preloads to follow loads in some cases. Also, there may be varying number of loads, stores and preloads in the loop, in order to match the total number of bytes loaded or stored with the total number of bytes preloaded each time through the loop. For example, if each load instruction only loads thirty-two (32) bytes (by specifying one or more registers to load that can collectively hold thirty-two (32) bytes), and each preload only loads one hundred twenty eight (128) bytes, there might be four loads in the loop for each preload. Many load and store instructions hold as few as four (4) bytes, so many loads and stores are needed for each preload instruction. And, there could be multiple preload instructions per loop for some multiple of preload size (PLDSize) processed per loop.

Also, there may be extra software instructions provided to handle the remainder of data that is not a multiple in size of preload size (PLDSize) (when DataSize modulo PLDSize is not zero). Also, note that some loops decrement a loop counter by one each time through the loop (rather than decrementing the number of bytes)—there are a number of equivalent ways loops can be structured.

The embodiments disclosed herein can also be implemented using prefetches in CPU hardware where the PLD instruction is not employed. For example, a CPU and cache may have the ability to “prefetch” data based on the recognition of data patterns. A simple example is when a cache memory reads a line from memory because of a request from the CPU. The cache memory is often designed to read the next cache line in cache memory in anticipation that the CPU will require this data in a subsequent data request. This is termed a speculative operation since the results may never be used.

The CPU hardware could recognize the idiom of a cached streaming read to a first memory address (addr1) register, a cached streaming read/write to a second memory address (addr2) register, and a decrementing register that is used as the data streaming size. The CPU hardware could then automatically convert the first memory address (addr1) stream to an optimized series of preloads, as described by this disclosure. It is also possible that a software hint instruction could be created to indicate to the CPU hardware to engage this operation. The CPU hardware calculates a preload offset (pld_offset) conforming to a set of rules, which when added to the first memory address (addr1) data stream, can create a stream of preloads to memory which will always access a different interleaved memory as the second memory address (addr2) stream. The second memory address (addr2) can be either a read or a write data stream. This allows the interleaved memory banks of cache memory or other memory to be accessed in parallel, thereby increasing bandwidth by utilizing the bandwidth of all interleaved memory banks. If more than two (2) interleaved devices exist, this approach can be applied multiple times.

The accelerated interleaved memory data transfers in microprocessor-based systems according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

In this regard, FIG. 10 illustrates an example of a processor-based system 70 that can employ accelerated interleaved memory data transfers according to the embodiments disclosed herein. In this example, the processor-based system 70 includes one or more central processing units (CPUs) 72, each including one or more processors 74. The CPU(s) 72 may have cache memory 76 coupled to the processor(s) 74 for rapid access to temporarily stored data, and which may include interleaved memory and be used for data transfers as discussed above. The CPU(s) 72 is coupled to a system bus 78 and can inter-couple master devices and slave devices included in the processor-based system 70. As is well known, the CPU(s) 72 communicates with these other devices by exchanging address, control, and data information over the system bus 78. For example, the CPU(s) 72 can communicate bus transaction requests to the memory controller 80 as an example of a slave device. Although not illustrated in FIG. 10, multiple system buses 78 could be provided, wherein each system bus 78 constitutes a different fabric.

Other devices can be connected to the system bus 78. As illustrated in FIG. 10, these devices can include a system memory 82 (which can include program store 83 and/or data store 85), one or more input devices 84, one or more output devices 86, one or more network interface devices 88, and one or more display controllers 90, as examples. The input device(s) 84 can include any type of input device, including but not limited to input keys, switches, voice processors, etc. The output device(s) 86 can include any type of output device, including but not limited to audio, video, other visual indicators, etc. The network interface device(s) 88 can be any devices configured to allow exchange of data to and from a network 92. The network 92 can be any type of network, including but not limited to a wired or wireless network, private or public network, a local area network (LAN), a wide local area network (WLAN), and the Internet. The network interface device(s) 88 can be configured to support any type of communication protocol desired.

The CPU 72 may also be configured to access the display controller(s) 90 over the system bus 78 to control information sent to one or more displays 94. The display controller(s) 90 sends information to the display(s) 94 to be displayed via one or more video processors 96, which process the information to be displayed into a format suitable for the display(s) 94. The display(s) 94 can include any type of display, including but not limited to a cathode ray tube (CRT), a liquid crystal display (LCD), a plasma display, etc.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for transferring data on a computing device that includes interleaved memory constructs and is capable of issuing an asynchronous load of data to a cache memory in advance of the data being used by a processor, each memory construct is separated from a previous memory construct by an address interleave size, the method comprising:
receiving a first read address associated with a read data stream and receiving a second address that is associated with a second data stream, the second data stream is one of a read or write data stream;
obtaining a minimum preload offset that is based, at least in part, upon the speed of the memory constructs, the minimum preload offset specifies a number of sequential addresses in advance that the asynchronous load must read in order to receive data at the cache memory from a slower memory before the processor accesses the data using the first memory address;
calculating a next available interleaved memory address which is in a next adjacent interleave to the second address by adding the obtained interleave size to the second address;
calculating a minimum preload address by adding the obtained minimum preload offset to the first address;
calculating a raw address distance by subtracting the minimum preload address from the next available interleaved address;
calculating an interleave size mask based upon an interleave stride and an interleave count to strip the higher-order bits from the raw address distance to produce a raw offset from the minimum preload address to a preferred memory preload address;
calculating a final preload offset from the first read address by adding the minimum preload distance to the calculated raw offset; and
using the final preload offset to address-align memory addresses to prevent the read data stream and the second data stream from simultaneously utilizing the memory constructs thereby accelerating the transfer of the data.

2. The method of claim 1, wherein the minimum preload address is less than or equal to the next available interleaved memory address and the raw address distance is a positive number.

3. The method of claim 1, wherein the minimum preload address is greater than the next available interleaved memory address and the raw address distance is a negative number.

4. The method of claim 1, including:
recognizing a current pattern of the read data stream; and
preloading, based on the current pattern of the read data stream, future data with the final preload offset.

5. A computing device comprising:
a processor to perform operations on data;
a cache memory coupled to the processor to store the data;
at least two memory constructs where each memory construct is separated from the previous memory construct by an address interleave size;
means to issue an asynchronous load of the cache memory in advance of the load data usage, the asynchronous load is one of a software preload instruction or a hardware data prefetch in which the computing device does not wait for the data to be loaded from memory;
means for receiving a first read address associated with a read data stream and receiving a second address that is associated with a second data stream, the second data stream is one of a read or write data stream;
means for obtaining a minimum preload offset that is based, at least in part, upon a speed of the memory constructs, the minimum preload offset specifies a number of sequential addresses in advance that the asynchronous load must read in order to receive data at the cache memory from a slower memory before the processor accesses the data using the first memory address;
means for calculating a next available interleaved memory address which is in a next adjacent interleave to the second address by adding the obtained interleave size to the second address;
means for calculating a minimum preload address by adding the obtained minimum preload offset to the first address;
means for calculating a raw address distance by subtracting the minimum preload address from the next available interleaved address;
means for calculating an interleave size mask based upon an interleave stride and an interleave count to strip the higher-order bits from the raw address distance to produce a raw offset from the minimum preload address to a preferred memory preload address;
means for calculating a final preload offset from the first read address by adding the minimum preload distance to the calculated raw offset; and
means for using the final preload offset to address-align memory addresses to prevent the read data stream and the second data stream from simultaneously utilizing the memory constructs thereby accelerating the transfer of the data.

6. The computing device of claim 5, wherein the interleave stride and the interleave count are stored in system registers of the processor.

7. The computing device of claim 5, wherein the means for calculating a next available interleaved memory address, the means for calculating a minimum preload address, the means for calculating a raw address distance, the means for calculating an interleave size mask, and the means for calculating a final preload offset include logic components implemented in hardware of the processor.

8. The computing device of claim 5, wherein the means for calculating a next available interleaved memory address, the means for calculating a minimum preload address, the means for calculating a raw address distance, the means for calculating an interleave size mask, and the means for calculating a final preload offset include non-transitory processor executable instructions stored in memory.

9. A non-transitory, tangible processor readable storage medium, encoded with processor readable instructions to perform a method for transferring data on a computing device, the method comprising:
receiving a first read address associated with a read data stream and receiving a second address that is associated with a second data stream, the second data stream is one of a read or write data stream;
obtaining a minimum preload offset that is based, at least in part, upon the speed of the memory constructs, the minimum preload offset specifies a number of sequential addresses in advance that the asynchronous load must read in order to receive data at the cache memory from a slower memory before the processor accesses the data using the first memory address;
calculating a next available interleaved memory address which is in a next adjacent interleave to the second address by adding the obtained interleave size to the second address;
calculating a minimum preload address by adding the obtained minimum preload offset to the first address.
calculating a raw address distance by subtracting the minimum preload address from the next available interleaved address;
calculating an interleave size mask based upon an interleave stride and an interleave count to strip the higher-order bits from the raw address distance to produce a raw offset from the minimum preload address to a preferred memory preload address;
calculating a final preload offset from the first read address by adding the minimum preload distance to the calculated raw offset; and
using the final preload offset to address-align memory addresses to prevent the read data stream and the second data stream from simultaneously utilizing the at least two memory constructs thereby accelerating the transfer of the data.

10. The non-transitory, tangible processor readable storage medium of claim 9, wherein the minimum preload address is less than or equal to the next available interleaved memory address and the raw address distance is a positive number.

11. The non-transitory, tangible processor readable storage medium of claim 9, wherein the minimum preload address is greater than the next available interleaved memory address and the raw address distance is a negative number.

12. The non-transitory, tangible processor readable storage medium of claim 9, wherein the method includes:
recognizing a current pattern of read data; and
preloading, based on the current read pattern of read data, future data with the final preload offset.

13. A computing device comprising:
at least two memory constructs, each memory construct is separated from a previous memory construct by an address interleave size;
a cache memory coupled to store data from the memory constructs; and
a processor coupled to the cache memory, the processor including:
registers to store a first read address associated with a read data stream and a second address that is associated with a second data stream, the second data stream is one of a read or write data stream;
system registers including a minimum preload offset, an interleave stride and an interleave count;
raw offset logic to determine a raw offset utilizing the first read address, the second address, the interleave stride, the interleave count, and the minimum preload offset;
logic to add the raw offset to the minimum preload offset to obtain a final preload offset; and
a data prefetch generation component that uses the final preload offset to prefetch data that is one interleave away from data being accessed at the second address to prevent the read data stream and the second data stream from simultaneously utilizing the memory constructs.

14. The computing device of claim 13, wherein the raw offset logic includes:
raw address distance logic to generate a raw address distance;
interleave mask logic to generate an interleave size mask; and
AND logic to AND the raw address distance and the interleave size mask to obtain the raw offset.

15. The computing device of claim 14, wherein the raw address distance logic includes:
first add logic to add the second address to the interleave stride to obtain a next available interleaved memory address;
second add logic to add the first read address to the minimum preload offset to obtain a minimum preload address; and
subtraction logic to subtract the minimum preload address from the next available interleaved memory address to obtain the raw address distance.

16. The computing device of claim 13, wherein the data prefetch generation component includes:
pattern recognition logic to recognize a current pattern of the read data stream and the second data stream; and
a preload command generation component to preload, based on the current pattern of the read data stream, future data with the final preload offset.
